(19) United States
(12) Patent Application Publication
(10) Pub. No.: US 2010/0037451 A1
(43) Pub. Date: Feb. 18, 2010

(54) Method of material selection and forming to solve aging of one inductor's iron core

(76) Inventor: Chang-Mao Cheng, Taoyuan (TW)

Correspondence Address: BACON & THOMAS, PLLC, 625 SLATERS LANE, FOURTH FLOOR, ALEXANDRIA, VA, 22314-1176, US

(21) Appl. No.: 12/222,549

(22) Filed: Aug. 12, 2008

(51) Int. Cl. H01F 7/06

(52) U.S. Cl. 29/602.1

(57) ABSTRACT

This invention of one method with respect to material selection and forming to solve aging of one inductor's iron core comprises materials such as iron powder, insulating compound, thinner, adhesive, and lubricant at least for mixing, agitating, and heating according to weight percentages of materials selected where a layer of protection film formed on surfaces of insulated powder particles by adhesives makes particles sustain the glass transition temperature of 600 Celsius degrees or so and one inductor with an aging-resistant feature is generated with a mixture held inside one mold cavity for a die-casting process via the powder metallurgy technique and then high-temperature sintering.

### BACKGROUND OF THE INVENTION

1. Field of the Invention

This invention of one method with respect to material selection and forming to solve aging of one inductor's iron core is one manufacture process to make one heated iron core prevent from aging.

2. Description of the Prior Art

As one important electronic element in electronic products, an inductor with functions of filtering noise within currents, stabilizing currents in circuits, and preventing electromagnetic interference has similar effects like one capacitor to save and release electronic energy in circuits for adjusting stability of currents. As a result of mutual transformation between electricity and magnetism, one magnetic field will be generated around a conducting wire with currents passing; comparatively, currents will be generated within one coil cutting magnetic lines of force. With extensive applications, inductors are used in lots of alliances such as power supply, monitor, switchboard, mother board, scanner, telephone set, and modem.

The categories for inductors (as shown from FIG. 1-1 to FIG. 1-5) includes: one hollow circular iron core with one coil having a certain circles winded around; one E/I-type iron core with one solid tubular coil having a certain circles and flat & bended terminals winded around; one E/I-type iron core with one flat coil having a certain circles and bended terminals winded around; one E/I-type iron core with one flat circular coil extending toward both sides to form bended terminals; one E/I-type iron core with one solid tubular coil having a certain circles winded around and terminals extending toward one side. In this regard, the said inductors' types are designed for no other than stabilization of currents in electronic products. Furthermore, as one important portion inside one inductor, the iron core with features of insulation, high temperature resistance, and no heat fading provides better durable properties for precise electronic products.

According to the patent application U.S. Pat. No. 7,281,315 and U.S. Pat. No. 7,142,084 filed by the applicant, the E/I-type inductor's iron core through mixing, die-casting and then sintering of selected materials including insulating compounds (Polyester resins), thinners (acetone), epoxy resins, silicone, lubricants (zinc stearate) is implanted with one winding coil for a punching & combination process under 250 Celsius degrees with epoxy resins and silicone having the glass transition temperature of 120˜160 Celsius degrees added to make a layer of heat-resistant protection film on surfaces of insulated powder particles. Drawbacks from materials selected for manufacture of this iron core: consumption of the entire iron core and coil from iron loss and copper loss due to damage of the protection film at high temperatures of an electronic product; short lifetime; poor stability; employment efficiency, cost, and consumption owing to high reject rates from errors in a die-casting process for combination of the iron core out of E/I-type inductors separately casted.

Based on the said fact regarding various drawbacks, the inventor considering materials with features of sustaining high currents, aging-resistant, and heat-resistant for manufacture of the inductor's iron core as prerequisites coordinates all materials by adequate weight percentage for thermoforming to exclude flaws of known inductors.

### SUMMARY OF THE INVENTION

This invention of one method with respect to material selection and forming to solve aging of one inductor's iron core is to add adhesives (0.476%˜7.56%) enduring temperatures over 500 Celsius degrees into the recipe to form a layer of heat-resistant protection film on surfaces of magnetic powder particles, making one inductor have aging-resistant effects under heating.

To this end, this invention with respect to material selection to solve aging of one inductor's iron core contains ingredients with the following concentrations (by weight percentage):
a. Iron powder: 100%;
b. Insulating compound: 0.9%˜5.04%;
c. Thinner: 3.8%˜6.72%;
d. Adhesive: 0.476%˜7.56%;
e. Lubricant: 0.285%˜0.84%;

On the other hand, this invention with respect to forming to solve aging of one inductor's iron core contains the following steps, as shown in FIG. 2:
a. Primary mixing: Agitate iron powder, insulating compounds, and thinners mixed in accordance with adequate weight percentages to become a mixture;
b. Heating: Heat the mixture to generate insulating ferric phosphate compounds from iron powder;
c. Secondary mixing: Agitate the insulating mixture with adhesives and thinners added by weight percentages to become a new mixture;
d. Heating: Make surfaces of mixed particles form a layer of heat-resistant protection film by way of heating and drying the mixture;
e. Addition of lubricants: Agitate the mixture with the secondary mixing completed and lubricants added;
f. Die-casting: Hold the uniformly agitated mixture inside one fixture for die-casting by way of the powder metallurgy technique;
g. Heating and sintering: Finalize the object with a die-casting process completed by way of heating & sintering;
h. Painting: Print patterns or written characters on surfaces of the finalized inductor with a sintering process completed.

With an illustration of diagrams, the detailed description and technical content related to this invention is displayed as follows:

### DETAILED DESCRIPTION OF THE PREFERRED EMBODIMENTS

Refer to FIG. 2 indicating the steps with respect to an embodiment of this invention for the purpose of instructions only without restrictions of patent applications.

In this embodiment, one method for material selection and forming to solve aging of one inductor's iron core contains the following steps:
a. Primary mixing:
   Agitate iron powder, insulating compounds and thinners mixed in accordance with adequate weight percentages to become a mixture;
b. Heating:
   Heat the mixture to generate insulating ferric phosphate compounds from iron powder;
c. Secondary mixing:
   Agitate the mixture with adhesives and thinners added by adequate weight percentages to become a new mixture after the primary mixing is completed;
d. Heating:
   Make surfaces of mixed particles form a layer of heat-resistant protection film by way of heating and drying the mixture;
e. Addition of lubricants:
   Agitate the mixture with the secondary mixing & heating process completed and lubricants added;
f. Die-casting:
   Hold the uniformly agitated mixture inside one fixture for die-casting by way of the powder metallurgy technique;
g. Heating and sintering:
   Finalize the object with a die-casting process completed by way of heating & sintering;
h. Painting:
   Print patterns or written characters on surfaces of the finalized inductor with a sintering process completed.

Instructions for the method with respect to material selection and forming to solve aging of one inductors' iron core, investigated by the inventor, are shown as follow:

The following content indicates ingredients'concentrations (by weight percentage) for this invention of one method with respect to material selection and forming to solve aging of one inductor's iron core:

| | | Weight |
|---|---|---|
| Ingredient | | percentage (%) |
| Iron powder | Reduced iron powder or spray iron powder | 100% |
| Insulating | Phosphoric acid | 0.9%~5.04% |
| compound | | |
| Thinner | Acetone | 3.8%~6.72% |
| Adhesive | Silicon resin or other materials enduring | 0.476%~7.56% |
| | temperatures over 500 Celsius degrees | |
| Lubricant | Zinc stearate | 0.285%~0.84% |

The method for forming:
a. Agitate iron powder, insulating compounds and thinners mixed in accordance with adequate weight percentages to become a mixture;
b. Heat the mixture for 75˜90 minutes under temperatures of 110˜130 Celsius degrees for curing & drying of insulating compounds and insulating ferric phosphate compounds formed on surfaces of iron powder;
c. Agitate the mixture including insulating iron powder with adhesives and thinners added by adequate weight percentages to become a new mixture;
d. Heat the new mixture for 45˜60 minutes under temperatures from 90 to 100
   Celsius degrees for the purpose of drying this mixture and forming a layer of heat-resistant protection film on surfaces of particles in the mixture;
e. Agitate the dry mixture with the secondary mixing completed and lubricants added;
f. Hold the uniformly agitated mixture inside one fixture for a die-casting process by way of the powder metallurgy technique;
g. Finalize the object with a die-casting process completed through a 45˜60 minute sintering process under temperatures from 420 to 470 Celsius degrees;
h. Print patterns or written characters on surfaces of the finalized inductor with a sintering process completed.

Iron powder chosen in the said material selection for this invention is powder particles fabricated by the powder metallurgy technique and with the Curie temperature of 720 Celsius degrees and the weight percentage of 100%, either reduced iron powder as one better embodiment or spray iron powder as another case.

For the sake of a better insulating status for one inductor, phosphoric acid with acid-proof, high temperature-resistant and radiation-resistant features can be chosen as an insulating compound with weight percentages from 0.9% to 5.04% for generation of ferric phosphate compounds with insulating effects from this heated mixture.

To maintain one inductor's aging-resistant and high temperature-resistant features, silicon resins or other materials enduring over 500 Celsius degrees are chosen as adhesives for a better heat-resistant feature and an excellent electric insulation effect. With the said material (weight percentages from 0.476% to 7.56%) added, a layer of heat-resistant protection film formed on surfaces of heated and dried powder particles is able to prevent this inductor from iron loss & copper loss or aging and make it stabilized and with longer lifetime under a high temperature status.

To ensure one effectively diluted mixture, thinners added into mixtures in the primary mixing stage and the secondary mixing stage can prompt mixing where acetone as the thinner added has weight percentages from 3.8% to 6.72%;

For mixtures in the primary mixing stage and the secondary mixing stage with a drying process completed through heating from 80 to 100 Celsius degrees, zinc stearate as a lubricant with features of preventing non-vulcanized glues from adhesion and affecting no physical property of adhesion, a melting point of 120 Celsius degrees, and weight percentages from 0.285% to 0.84% for additives can be added. With an addition completed, a die-casting process via the powder metallurgy technique together with a 60-minute high-temperature sintering at a temperature of 450 Celsius degrees will vaporize lubricants with its melting point of 120 Celsius degrees in a nebulization process as a result of high-temperature sintering at 450 Celsius degrees.

To make one inductor have an aging-resistant feature under heating, the inventor after constant studying realizes that a mixture with silicon resins (weight percentages from 0.476% to 7.56%) or other materials enduring temperatures over 500 Celsius degrees added is heated for about 60 minutes at temperatures from 80 to 100 Celsius degrees to make a layer of aging-resistant protection film on surfaces of powder particles inside the mixture under a heating process for the inductor formed inside a die-casting process and sintered under a high temperature of 450 Celsius degrees. In this fashion, the inductor is able to sustain high temperatures in operations, but suffers from copper loss and ultra-low iron loss to materialize aging-resistant effects under heating in case of temperatures over an endurable temperature.

### BRIEF DESCRIPTION OF THE DRAWINGS

FIG. 1-1 is a schematic diagram of one inductor.

FIG. 1-2 is a schematic diagram of one inductor.

FIG. 1-3 is a schematic diagram of one inductor.

FIG. 1-4 is a schematic diagram of one inductor.

FIG. 1-5 is a schematic diagram of one inductor.

FIG. 2 is a schematic diagram for manufacture steps of this invention of one method with respect to material selection and forming to solve aging of one inductor's iron core.

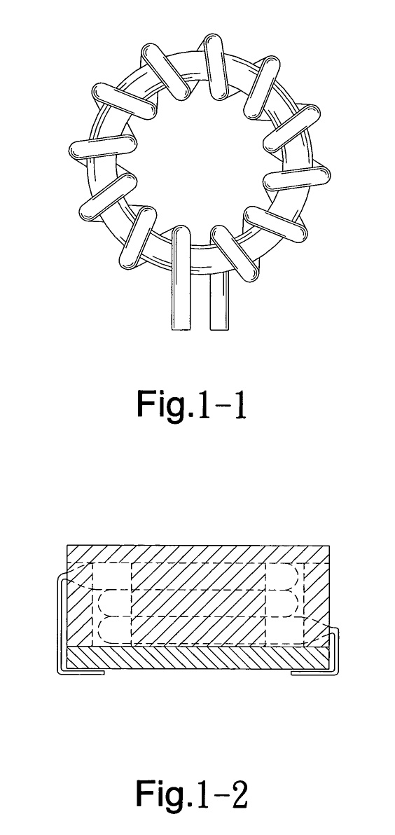

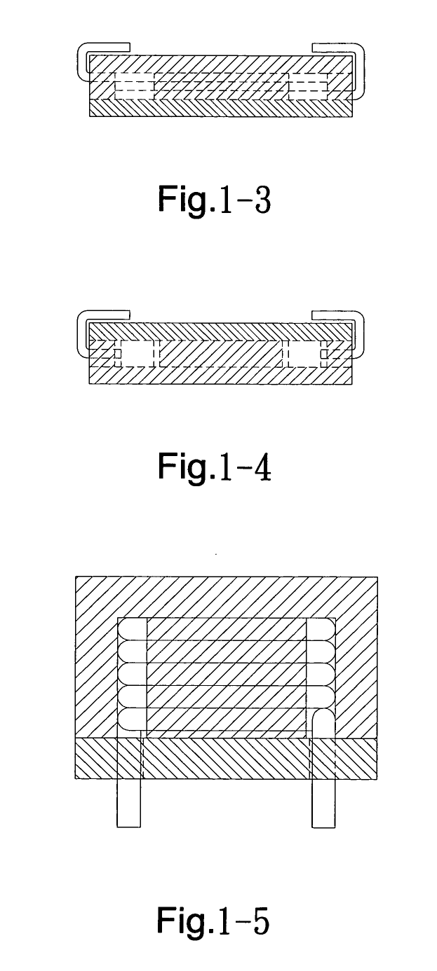

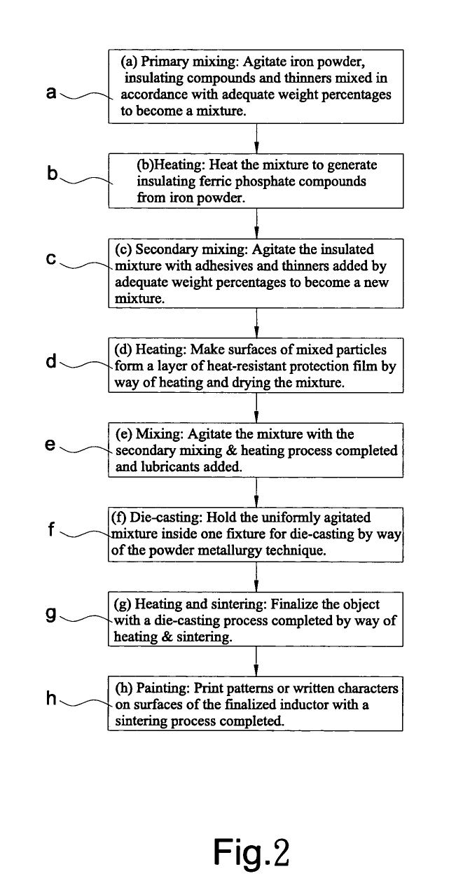

What is claimed is:

1. The method with respect to material selection and forming to solve aging of one inductor's iron core makes the iron core sustain high temperatures and increases the iron core's lifetime and stability without phenomenon of iron loss greater than copper loss due to high temperatures; materials selected for the iron core comprises iron powder, insulating compound, thinner, adhesive, and lubricant mainly where the lubricant is either silicon resins or other materials enduring over 500 Celsius degrees as additives due to their high temperature-resistant feature to materialize aging-resistance by increasing the iron core's property of enduring higher temperatures.

2. The method with respect to material selection and forming to solve aging of one inductor's iron core according to claim 1, where the iron powder is selected from reduced iron powder or spray iron powder and its mixtures.

3. The method with respect to material selection and forming to solve aging of one inductor's iron core according to claim 1, where the insulating compound is selected from phosphoric acid.

4. The method with respect to material selection and forming to solve aging of one inductor's iron core according to claim 1, where the thinner is selected from acetone.

5. The method with respect to material selection and forming to solve aging of one inductor's iron core according to claim 1, where the adhesive is either silicon resins or other materials enduring temperatures over 500 Celsius degrees.

6. The method with respect to material selection and forming to solve aging of one inductor's iron core according to claim 1, where the lubricant is selected from zinc stearate.

7. Materials selected for the method with respect to material selection and forming to solve aging of one inductor's iron core include iron powder, insulating compound, thinner, adhesive, and lubricant which constitute a mixture by the following method where concentrations (by weight percentage) and steps are shown as follows:
Iron powder: 100%;
Insulating compound: 0.9%˜5.04%;
Thinner: 3.8%˜6.72%;
Adhesive: 0.476%˜7.56%;
Lubricant: 0.285%˜0.84%;
a. Agitate iron powder (100%), insulating compound (0.9%˜5.04%), and thinner (3.8%˜6.72%) by adequate weight percentages to become a mixture;
b. Heating the mixture to dry and cure insulating compounds and to form insulated ferric phosphate compounds on surfaces of powder particles;
c. Agitate the insulating iron powder mixture with adhesives (0.476%˜7.56%) and thinners (3.8%˜9372%) added to become another mixture;
d. Heat the mixture to dry additives and make a layer of heat-resistant protection film on surfaces of particles within the mixture;
e. Add lubricants (0.285%˜0.84%) into the dried mixture through heating after the secondary mixing for another agitation and mixing;
f. Hold the uniformly agitated mixture inside one fixture for a die-casting process via the powder metallurgy technique;
g. Finalize the object with a die-casting process completed by heating and sintering; and
h. Print patterns and written characters on the finalized inductor with a sintering process completed.

8. The method with respect to material selection and forming to solve aging of one inductor's iron core according to claim 7, where Step b is to heat a mixture for 75˜90 minutes at temperatures from 110 to 130 Celsius degrees to generate ferric phosphate.

9. The method with respect to material selection and forming to solve aging of one inductor's iron core according to claim 7, where Step d is to heat a mixture for 45˜60 minutes at temperatures from 80 to 100 Celsius degrees for heating, mixing and drying.

10. The method with respect to material selection and forming to solve aging of one inductor's iron core according to claim 7, where Step g is to heat the object completing a die-casting process for 60 minutes at a temperature of 450 Celsius degrees for heating and sintering.
